(19) United States
(12) Patent Application Publication
(10) Pub. No.: US 2014/0358595 A1
(43) Pub. Date: Dec. 4, 2014

(54) PARKING RESERVATION THAT ENCOURAGES CAR-POOLING

(71) Applicant: International Business Machines Corporation, Armonk, NY (US)

(72) Inventors: Douglas Stuart Brown, Charlotte, NC (US); John Falk Kelley, Clarkesville, GA (US); Todd Seager, Orem, UT (US); Robert J. Torres, Cowlleyville, TX (US)

(21) Appl. No.: 13/906,507

(22) Filed: May 31, 2013

(51) Int. Cl. G06Q 50/30; G06Q 10/02

(52) U.S. Cl. CPC G06Q 50/30; G06Q 10/02
USPC 705/5

(57) ABSTRACT

A method, system, and computer program product for parking reservation that encourages car-pooling are provided in the illustrative embodiments. A processor, at a first mobile data processing system representing an automobile, receives an input to create a reservation for a parking location. A second mobile data processing system is detected, wherein the second mobile data processing system is within a threshold distance of the first mobile data processing system. A determination is made whether a movement of the second mobile data processing system relative to the first mobile data processing system is less than a threshold measure of the movement. Responsive to the determining being affirmative, a qualifier is applied to the reservation to obtain a benefit in the reservation, wherein the qualifier accrues a benefit to the reservation.

### TECHNICAL FIELD

The present invention relates generally to a method, system, and computer program product for reserving parking for automobiles. More particularly, the present invention relates to a method, system, and computer program product for parking reservation that encourages car-pooling.

### BACKGROUND

A parking location is a designated place to park an automobile. A parking meter is one example of a parking location. A parking space equipped with a device to convey to users that the space is reserved or available for parking an automobile is another example of a parking location.

Finding a parking location under certain circumstances is not an easy task. Particularly, at crowded, built-up, or popular destinations, a user often has to drive around the parking area for a significant amount of time before finding a parking location.

The increase in the amount of space that can be allocated for parking automobiles has not kept up with the increasing number of automobiles on the streets. Finding a parking location at many destinations is going to become increasingly difficult as more people and more automobiles head to those destinations.

### SUMMARY

The illustrative embodiments provide a method, system, and computer program product for parking reservation that encourages car-pooling. An embodiment receives, by using a processor at a first mobile data processing system representing an automobile, an input to create a reservation for a parking location. The embodiment detects, by using the processor at the first mobile data processing system, a second mobile data processing system, wherein the second mobile data processing system is within a threshold distance of the first mobile data processing system. The embodiment determines, by using the processor at the first mobile data processing system, whether a movement of the second mobile data processing system relative to the first mobile data processing system is less than a threshold measure of the movement. The embodiment applies, by using the processor at the first mobile data processing system, responsive to the determining being affirmative, a qualifier to the reservation to obtain a benefit in the reservation, wherein the qualifier accrues a benefit to the reservation.

Another embodiment includes one or more computer-readable tangible storage devices. The embodiment further includes program instructions, stored on at least one of the one or more storage devices, to receive at a first mobile data processing system representing an automobile, an input to create a reservation for a parking location. The embodiment further includes program instructions, stored on at least one of the one or more storage devices, to detect a second mobile data processing system, wherein the second mobile data processing system is within a threshold distance of the first mobile data processing system. The embodiment further includes program instructions, stored on at least one of the one or more storage devices, to determine whether a movement of the second mobile data processing system relative to the first mobile data processing system is less than a threshold measure of the movement. The embodiment further includes program instructions, stored on at least one of the one or more storage devices, to apply, responsive to the determining being affirmative, a qualifier to the reservation to obtain a benefit in the reservation, wherein the qualifier accrues a benefit to the reservation.

Another embodiment includes one or more processors, one or more computer-readable memories and one or more computer-readable tangible storage devices. The embodiment further includes program instructions, stored on at least one of the one or more storage devices for execution by at least one of the one or more processors via at least one of the one or more memories, to receive at a first mobile data processing system representing an automobile, an input to create a reservation for a parking location. The embodiment further includes program instructions, stored on at least one of the one or more storage devices for execution by at least one of the one or more processors via at least one of the one or more memories, to detect a second mobile data processing system, wherein the second mobile data processing system is within a threshold distance of the first mobile data processing system. The embodiment further includes program instructions, stored on at least one of the one or more storage devices for execution by at least one of the one or more processors via at least one of the one or more memories, to determine whether a movement of the second mobile data processing system relative to the first mobile data processing system is less than a threshold measure of the movement. The embodiment further includes program instructions, stored on at least one of the one or more storage devices for execution by at least one of the one or more processors via at least one of the one or more memories, to apply, responsive to the determining being affirmative, a qualifier to the reservation to obtain a benefit in the reservation, wherein the qualifier accrues a benefit to the reservation.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a process for parking reservation that encourages car-pooling in accordance with an illustrative embodiment;

FIG. 4 depicts a block diagram of the car-pooling function of a parking reservation application in accordance with an illustrative embodiment;

FIG. 5 depicts a flowchart of a process for parking reservation that encourages car-pooling in accordance with an illustrative embodiment; and

FIG. 6 depicts a flowchart of an example process for updating a parking reservation that uses car-pooling information in accordance with an illustrative embodiment.

### DETAILED DESCRIPTION

The illustrative embodiments recognize that driving around a parking area to find an available parking location is a wasteful use of fuel. Such driving also pollutes the environment.

The illustrative embodiments further recognize that often many individuals start from a common location and reach a common destination, albeit in different vehicle. Such driving patterns exacerbate the fuel consumption and pollution problems.

The illustrative embodiments used to describe the invention generally address and solve the above-described problems and other problems related to the scarcity of parking locations. The illustrative embodiments provide a method, system, and computer program product for parking reservation that encourages car-pooling.

The illustrative embodiments provide a system for reserving a parking location in advance to avoid the need to drive around to find a parking location. An embodiment incentivizes a user to travel with others in a common vehicle from one geographical area to another, to wit, car-pool (car-pooling), by modifying certain aspects of the reservation. For example, an embodiment detects the presence of multiple individuals in an automobile and makes or modifies a request for a parking location reservation such that a discount, promotion, privilege, advantage, benefit, priority, or an additional service is applied to the reservation.

An embodiment can be implemented using a mobile data processing device—such as a smartphone or a mobile computing device available with a driver of a vehicle, or using a data processing system associated with an automobile—such as a navigation system, a communication system, a computer, or a combination thereof present in the vehicle.

An embodiment detects the presence of an individual in proximity of the automobile where the embodiment is executing (the environment of the embodiment) by detecting the presence of another device or data processing system. An embodiment verifies that the other device or data processing system is within a threshold distance of the automobile, and that any relative movement between the other device or data processing system and the automobile is within a threshold measure of movement. Some example threshold measures of movement are a threshold speed of the movement, a total distance of the movement, an acceleration of the movement, a direction of the movement, duration of the movement, a frequency of the movement, and a size or amplitude of the movement.

An embodiment excludes from consideration in the reservation process those detected drivers or automobiles that may be proximate to the environment but who do not qualify as car-pool. For example, a person with a mobile device may be in a vehicle that is tailgating the environment of an embodiment within a threshold distance. However, the relative movement between the other vehicle and the environment of the embodiment may cause that distance to change by more than a foot or two during the course of travelling one half mile. The embodiment can use this example measure of movement to determine that the other device is in another vehicle, and therefore cannot be considered for applying a car-pool qualifier to the request for reserving a parking location.

The illustrative embodiments are described with respect to certain data processing systems, environment, distances, and measurements only as examples. Any specific manifestations of such artifacts are not intended to be limiting to the invention. Any suitable manifestation of data processing systems, environment, distances, and measurements can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

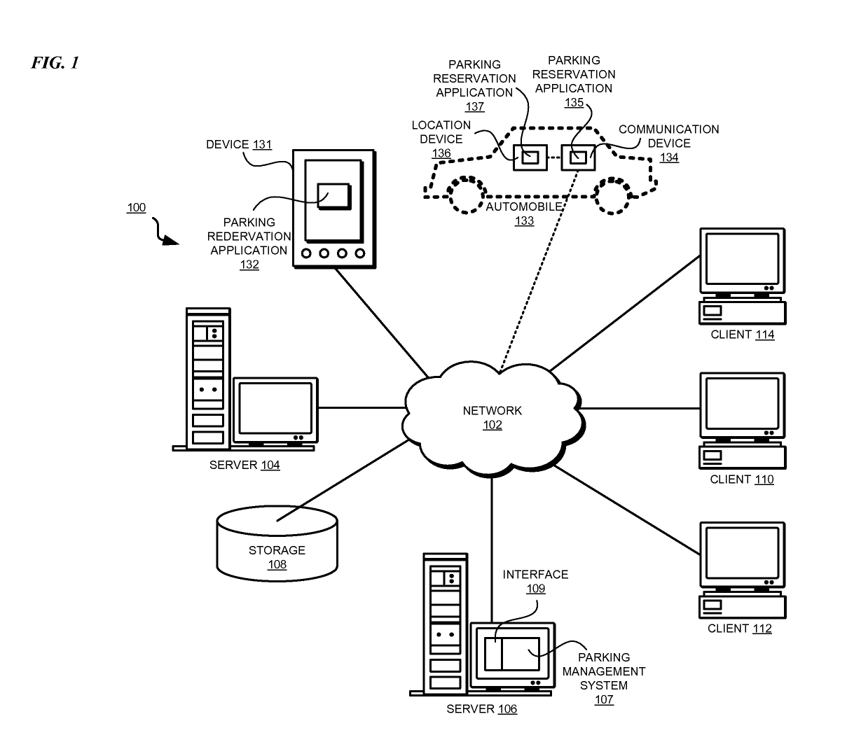

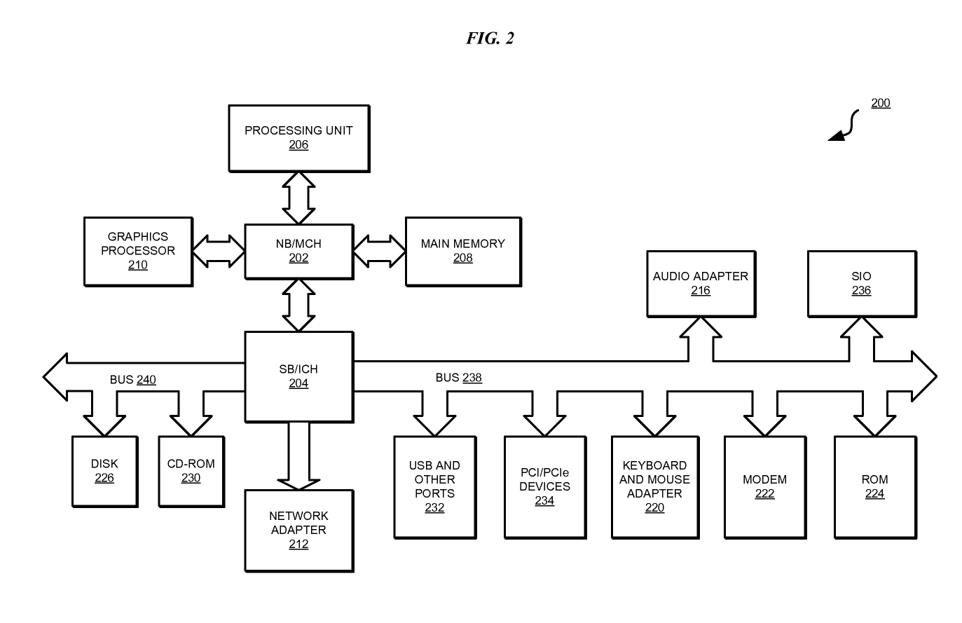

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114, may contain data and may have software applications or software tools executing thereon.

Only as an example, and without implying any limitation to such architecture, FIG. 1 depicts certain components that are usable in an example implementation of an embodiment. For example, server 106 implements parking management system 107. Parking management system 107 provides interface 109. An application, such as an application implementing an embodiment, can communicate with parking management system 107 via interface 109. Device 131 is any suitable mobile computing platform, for example, a smartphone, tablet computer, a portable data processing device, or a wearable computing device. Device 131 includes parking reservation application 132, which implements an embodiment described herein. Automobile 133 is any suitable automobile or vehicle that can accommodate more than one individual and needs space to park. As an example, automobile 133 may be a passenger car. Automobile 133 provides an environment for an embodiment to execute. Automobile 133 includes communication device 134. Communication device 134 may be a device embedded in automobile 133, removably attached to automobile 133, carried by a person in automobile 133, or otherwise associated with automobile 133 in any suitable manner. Communication device 134 provides data communication capabilities from automobile 133. Only as an example, and without implying a limitation thereto, communication device 134 may be a person's cellular phone that enables parking reservation application 135 executing thereon to communicate with parking management system 107 wirelessly. Parking reservation application 135 includes an embodiment described herein. Automobile 133 includes location device 136. Location device 136 may be a device embedded in automobile 133, removably attached to automobile 133, carried by a person in automobile 133, or otherwise associated with automobile 133 in any suitable manner. Location device 136 provides data about the location of automobile 133. Only as an example, and without implying a limitation thereto, location device 136 may be a global positioning system (GPS) enable device that provides location information to parking reservation application 137 executing thereon. Parking reservation application 137 includes an embodiment described herein. In one embodiment, communication device 134 and location device 136 communicate with each other, such as via a wireless network, and enable one instance of parking reservation application 135 or 137 to execute and make a parking reservation while encouraging car-pooling in accordance with the illustrative embodiments. The features of an embodiment can be implemented in communication device 134, location device 136, certain components of automobile 133, or a combination thereof, without limitation, and depending on the circumstances of a particular implementation.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, files related to the operating system and other software applications, and application features to clients 110, 112, and 114. Clients 110, 112, and 114 may be clients to server 104 in this example. Clients 110, 112, 114, or some combination thereof, may include their own data, boot files, operating system images, files related to the operating system and other software applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 112 in FIG. 1, or another type of device in which computer usable program code or instructions implementing the processes may be located for the illustrative embodiments. Data processing system 200 is also representative of a device, such as device 131 in FIG. 1 in which computer usable program code or instructions implementing the processes of the illustrative embodiments may be located for the illustrative embodiments. Data processing system 200 is also representative of an embedded, removable, or mobile computing device, such as an example implementation of communication device 134, location device 136, or a combination thereof, that can be associated with automobile 133 in FIG. 1 in which computer usable program code or instructions implementing the processes of the illustrative embodiments may be located for the illustrative embodiments. Data processing system 200 is described as a computer only as an example, without being limited thereto. Implementations in the form of device 131, 134, 136, or automobile 133 in FIG. 1 may modify data processing system 200 and even eliminate certain depicted components there from without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. A computer readable or usable storage device does not include propagation media. Hard disk drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as migration application 105 in FIG. 1, are located on at least one of one or more storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

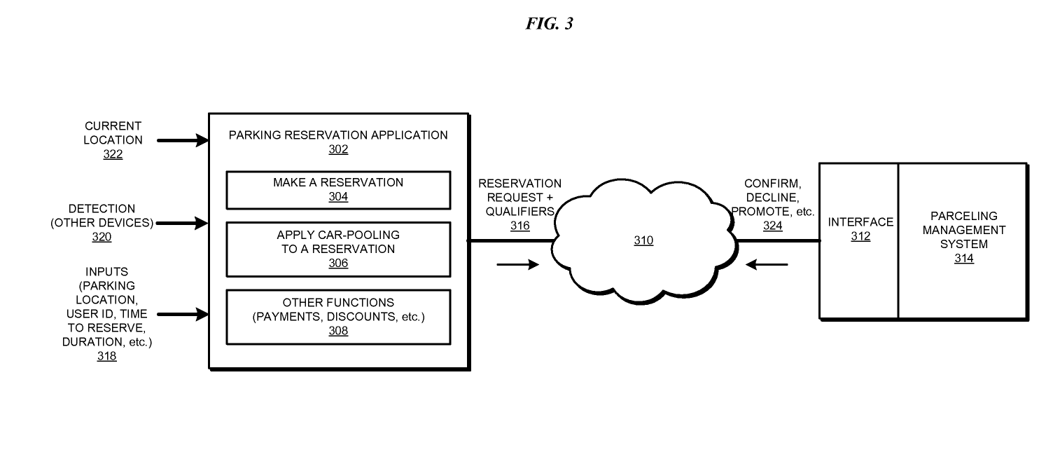

With reference to FIG. 3, this figure depicts a block diagram of a process for parking reservation that encourages car-pooling in accordance with an illustrative embodiment. Parking reservation application 302 can be implemented as parking reservation application 132, 135, or 137 in FIG. 1. Interface 312 and Parking management system 314 are embodiments of interface 109 and parking management system 107 in FIG. 1, respectively. Parking reservation application 302 communicates with parking management system 314 over data network 310. Network 310 is an example of network 102 in FIG. 1.

Parking reservation application 302 includes component 304, which composes a reservation request for reserving a parking location. Reservation request 316 is an example of reservation requests that can be composed using component 304. For example, reservation request 316 can be constructed according to a specification or protocol supported by interface 312.

Reservation request 316 includes at least an identifier associated with a user, an automobile, or both. For example, a driver of automobile 133 of FIG. 1 can have an identifier corresponding to the driver's license number. As another example, automobile 133 can have an identifier corresponding to a license plate number associated with automobile 133. Such an identifier informs parking management system 314 who is financially responsible for the reservation, what kind of vehicle to expect in the parking location, or both.

Reservation request 316 further includes an identifier associated with a destination where the parking location is desired. Reservation request 316 also includes information about a time-period for which the reservation is being made.

As an example, in one embodiment, parking reservation application 302 receives these example types of information in reservation request 316, such as a user identifier, a parking location, and reservation time-period via user input 318. In another example embodiment, parking reservation application 302 retrieves such information from a data repository, such as a memory device, where this type of information is stored for repeated use. In one embodiment, some of the information is provided via input 318 and some is retrieved from a data repository.

These example types of information in reservation request 316 are not intended to be limiting on the illustrative embodiments. Those of ordinary skill in the art will be able to conceive from this disclosure many additional or different types of information for similar purposes. Reservation request 316 can be configured with these types of information or variations thereof, and any additional or different number or types of information as may be suitable in a given implementation within the scope of the illustrative embodiments.

Parking reservation application 302 further includes component 306. Component 306 applies one or more car-pooling qualifiers to reservation request 316. For example, component 306 detects whether a greater than a threshold number of occupants are present in the automobile where parking reservation application 302 is executing.

In one embodiment, component 306 detects, via detection 320, whether another device associated with an individual other than the individual associated with the device where parking reservation application 302 is executing, is present within a threshold distance of the environment of parking reservation application 302. Component 306 also detects, via detection 320, whether the other device is col-located with the device where parking reservation application 302 is executing. In other words, component 306 detects whether the other device is moving relative to the environment within a threshold measure of movement. Co-location of devices occurs between two devices when one device is within a threshold distance of the other device and is either stationary relative to the other device, or is moving relative to the other within a threshold measure of movement.

For example, component 306 determines whether the other person's movement is within a threshold distance from the environment and closing, such as when a potential car-pool passenger approaches the automobile to join occupy a seat and join the car-pool. As another example, component 306 determines whether the other person is stationary relative to the environment, such as when the other person has occupied a seat in the automobile and has become a car-pool passenger.

component 306 determines whether a threshold number of devices or associated persons has been detected, such as 2 or more persons or devices, including the device or the individual associated with the device where parking reservation application 302 is executing. If the threshold number is met or exceeded, component 306 applies a car-pooling qualifier to reservation request 316. In one embodiment, a car-pooling qualifier is transmitted separate from reservation request 316, such as for modifying an existing reservation resulting from a previous instance of reservation request 316.

According to an embodiment, a car-pooling qualifier allows the reservation to qualify for a discount, promotion, privilege, advantage, benefit, priority, or an additional service (collectively benefits). For example, if reservation request 316 or a reservation resulting there from has a car-pool qualifier associated there with, the reservation may get a price reduction on the parking fees, cash-equivalent awards towards future parking reservations, priority parking according to preferred parking times or parking locations, a discount from a cooperating business, a credit, other similar benefit, or a combination thereof. These benefits are described here only as examples and are not intended to be limiting on the illustrative embodiments. Any number of these, different, or additional benefits can accrue to a reservation or a reservation account holder within the scope of the illustrative embodiments.

Other functions related to reserving a parking location are implemented in component 308. For example, in one embodiment, component 308 computes an estimated time of arrival (ETA) using current location 322 that may be available from a location device, such as location device 136 in FIG. 1. Computing and providing an ETA in reservation request 316 causes a parking cost to change, or a wait-listing for a preferred parking location to occur. Many other uses of the ETA information or current location information 322 will be apparent from this disclosure and the same are contemplated within the scope of the illustrative embodiments.

Component 308 can also perform other functions. For example, a user can make a payment for the parking, cash-in credits, apply other discounts, or manually enter car-pooling information for device-free passengers or passengers with non-compatible devices. The list of other functions described herein is not exhaustive. Many other parking-related functions will become apparent to those of ordinary skill in the art from this disclosure, and the same are contemplated within the scope of the illustrative embodiments. For example, component 308 can be implemented to perform a reservation request update upon certain conditions, events, or inputs (not shown), such as if the traffic conditions cause a delay enroute, and the driver wants to change a previous reservation to reservation for a more expensive preferred parking location closer to a destination.

Optionally, parking reservation application 302 receives response 324 from parking management system 314. Response 324 can include a confirmation of a reservation, a location of the reserved parking location, declination, cross-promotion of other businesses, error, request for additional information, a subsequent transaction for completing the reservation, any of a number of other possible responses, or a combination thereof, depending on the implementation.

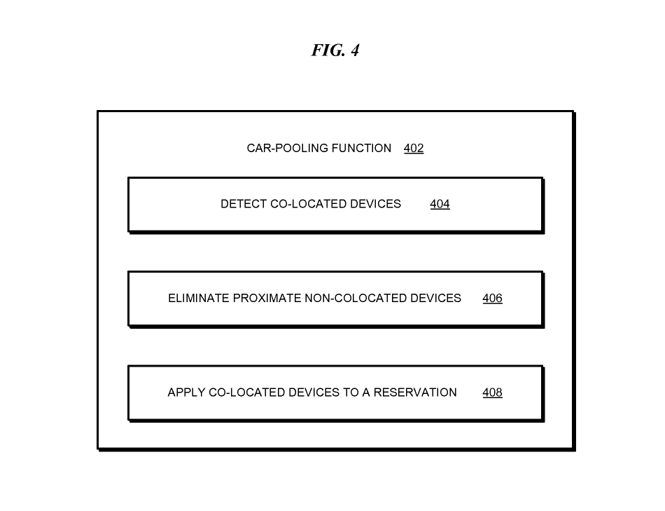

With reference to FIG. 4, this figure depicts a block diagram of the car-pooling function of a parking reservation application in accordance with an illustrative embodiment. Car-pooling function 402 is an example of component 306 in FIG. 3.

Function 402 implements detection function 404. Detection function 404 detects other co-located devices as described with respect to FIG. 3.

Function 402 implements elimination function 406. Elimination function 406 eliminates those devices that are detected in an embodiment's environment but that are not co-located with the device where the embodiment is executing. For example, a device associated with a person driving another vehicle in close proximity (within a threshold distance) with the vehicle where an embodiment is executing may be detected by car-pooling function 402. Over a period during the driving, the distance between the two vehicles may change or exceed the threshold, or the relative movement between the two devices may exceed a movement threshold such as a threshold speed or direction of movement. Under such circumstances, car-pooling function 402 recognizes that the detected device is not a car-pool member and should not be used for applying car-pool qualifiers to a reservation request or reservation. Thus, elimination function 406 eliminates such non-co-located devices from consideration in the parking reservation process.

Function 406 implements applying function 408. Applying function 408 determines whether a threshold number of co-located devices has been reached to create a car-pool qualifier. Applying function 408 applies the car-pool qualifier to a reservation request or reservation as described with respect to FIG. 3.

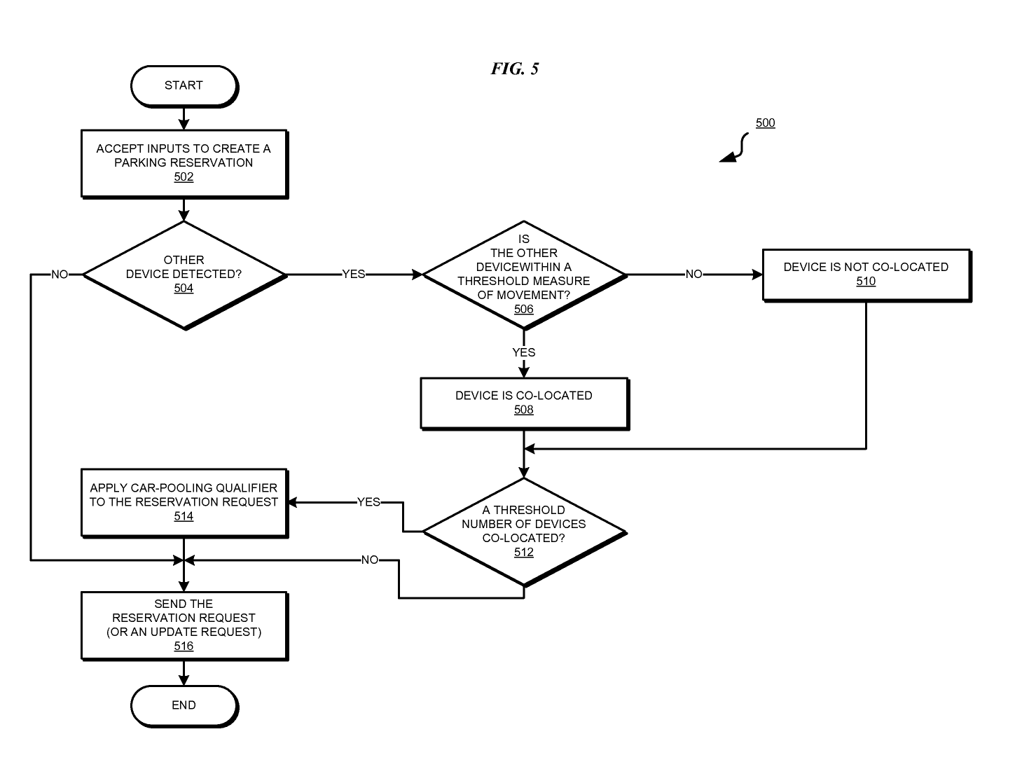

With reference to FIG. 5, this figure depicts a flowchart of a process for parking reservation that encourages car-pooling in accordance with an illustrative embodiment. Process 500 can be implemented in a parking reservation application, such as parking reservation application 302 in FIG. 3.

Process 500 begins by the parking reservation application accepting an input to create a parking reservation (step 502). The parking reservation application determines whether another device has been detected in the environment of the parking reservation application (step 504). For example, the parking reservation application detects that a device is in the parking reservation application's environment if the device is within a threshold distance from an automobile, including inside the automobile, which includes a device where the parking reservation application is executing.

If no other devices are detected in the environment of the parking reservation application (“No” path of step 504), the parking reservation application executes step 516. In one embodiment, the parking reservation application performs step 504 over a period, or a distance of travel, or both, before proceeding to step 516.

If the parking reservation application detects that the other device is in the environment of the parking reservation application (“Yes” path of step 504), the parking reservation application determines whether a relative movement of the other device with respect to the environment is within a threshold measure of movement (step 506). If the parking reservation application determines that the movement is within the threshold measure of movement (“Yes” path of step 506), the parking reservation application identifies the other device as a co-located device (step 508). If the parking reservation application determines that the movement is not within the threshold measure of movement (“No” path of step 506), the parking reservation application concludes that the other device is not a co-located device (step 510). Note that the parking reservation application may perform multiple evaluations of step 506 on the other device over a period, or over a distance of travel, or both, before proceeding to either step 508 or 510.

Following either step 508 or 510, the parking reservation application determines whether a threshold number of devices are co-located in the environment of the parking reservation application (step 512). If the threshold number of devices is co-located in the environment of the parking reservation application (“Yes” path of step 512), the parking reservation application applies a car-pooling qualifier to a reservation request (step 514). The parking reservation application sends the reservation request (step 516). Process 500 ends thereafter.

In one embodiment, the reservation request is a request to update an existing reservation, and the parking reservation application applies a car-pooling qualifier to the update request in step 514. In such a case, the parking reservation application sends the update request in step 516.

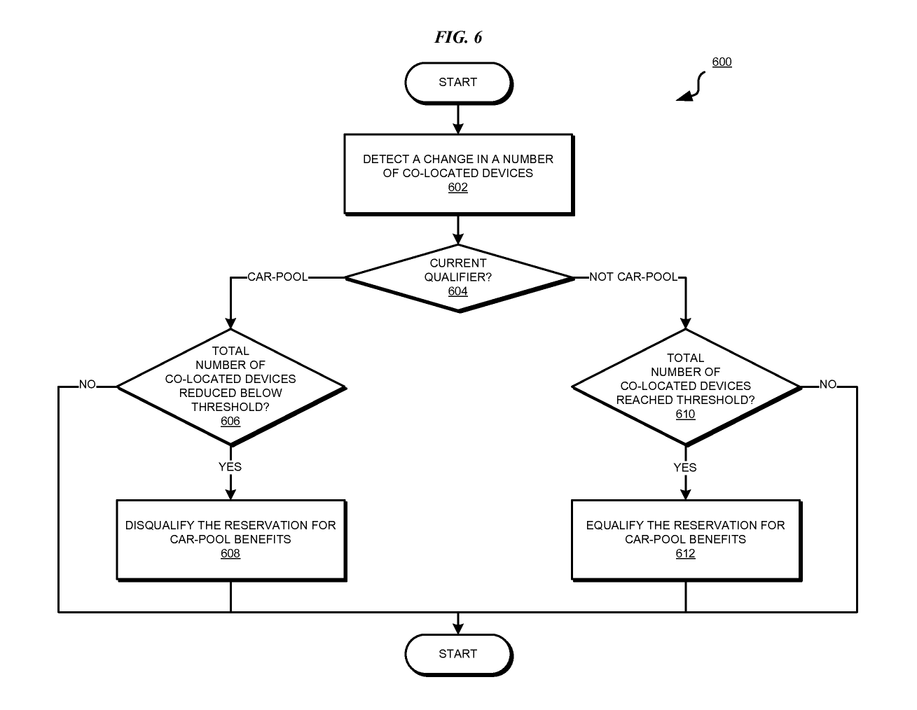

With reference to FIG. 6, this figure depicts a flowchart of an example process for updating a parking reservation that uses car-pooling information in accordance with an illustrative embodiment. Process 600 can be implemented in a parking reservation application, such as parking reservation application 302 in FIG. 3.

Occasionally, the number of co-located devices can change between the beginning of a trip and the end of a trip. For example, a group of people may start from one location, and the group may not be of the threshold size required for a car-pool status. Another passenger may join the group at some point partially through the trip. If a reservation for a parking location was made at the beginning of the trip, the reservation may not have reaped the benefits of a car-pool qualifier then. However, the additional passenger may cause the group to reach the threshold size.

Thus the reservation should be updated to utilize the car-pool benefits because the group qualifies for a car-pool status from that point in the trip until the parking location. Conversely, a group may start as a qualified car-pool, but may drop off a passenger at some point partially through the trip, thereby reducing the group to a non-car-pool status. Thus, a reservation that utilized the benefits of a car-pool qualifier should be updated to remove the car-pool benefits because the group no longer qualifies for a car-pool status from that point in the trip until the parking location. Process 600 is directed to such reservation updates.

Process 600 begins in the parking reservation application by detecting a change in a number of co-located devices (step 602). Process 600 determines whether the current reservation is made with a car-pool qualifier (step 604).

If the current reservation is made with a car-pool qualifier (“Car-pool” path of step 604), the parking reservation application determines whether the total number of co-located devices has reduced below a threshold number (step 606). If the total number of co-located devices has reduced below the threshold number (“Yes” path of step 606), the parking reservation application sends an update request to disqualify the current reservation for car-pool benefits (step 608). Process 600 ends thereafter. If the total number of co-located devices has not reduced below the threshold number (“No” path of step 606), process 600 ends thereafter.

If the current reservation is not made with a car-pool qualifier (“Not Car-pool” path of step 604), the parking reservation application determines whether the total number of co-located devices has reached a threshold number (step 610). If the total number of co-located devices has reached the threshold number (“Yes” path of step 610), the parking reservation application sends an update request to qualify the reservation for car-pool benefits (step 612). Process 600 ends thereafter. If the total number of co-located devices has not reached the threshold number (“No” path of step 610), process 600 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for parking reservation that encourages car-pooling. An embodiment provides a process for making a reservation for a parking location in advance of reaching the parking location, thereby avoiding the fuel costs and environmental impact from having to drive around to find a parking location. An embodiment further detects car-pooling qualifications at the beginning or during the travel to the parking location. An embodiment encourages car-pooling by providing discounts, promotions, privileges, advantages, benefits, priority, or additional services tied to car-pool status of the automobile upon reaching the parking location.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for parking reservation that encourages car-pooling, the method comprising:
receiving, by a processor at a first mobile data processing system representing an automobile, an input to create a reservation for a parking location;
detecting, by the processor at the first mobile data processing system, a second mobile data processing system, wherein the second mobile data processing system is within a threshold distance of the first mobile data processing system;
determining, by the processor at the first mobile data processing system, whether a movement of the second mobile data processing system relative to the first mobile data processing system is less than a threshold measure of the movement; and
applying, by the processor at the first mobile data processing system, responsive to the determining being affirmative, a qualifier to the reservation to obtain a benefit in the reservation, wherein the qualifier accrues a benefit to the reservation.

2. The method of claim 1, further comprising:
detecting that a device has joined the group of co-located devices;
evaluating whether a number of devices in the group of the co-located devices has reached a threshold number; and
setting, responsive to the number of devices in the group of the co-located devices reaching the threshold number, a status of the group of co-located devices as a car-pool.

3. The method of claim 1, further comprising:
detecting that a device has left the group of co-located devices;
evaluating whether a number of devices in the group of the co-located devices is less than a threshold number; and
setting, responsive to the number of devices in the group of the co-located devices being less than the threshold number, a status of the group of co-located devices as other than a car-pool.

4. The method of claim 1, further comprising:
concluding, responsive to the determining being affirmative, that the second mobile data processing system is co-located with the first mobile data processing system, the first and the second mobile data processing systems forming a group of co-located devices;
evaluating whether a number of devices in the group of the co-located devices exceeds a threshold number; and
setting, responsive to the number of devices in the group of the co-located devices exceeding the threshold number, a status of the group of co-located devices as a car-pool.

5. The method of claim 1, further comprising:
receiving a current location of the automobile;
computing an estimate of a time of arrival at the parking location; and
including the estimate in a parking reservation request to obtain a second benefit in the reservation.

6. The method of claim 1, wherein the movement comprises speed of the movement and the threshold measure of the movement comprises a threshold speed.

7. The method of claim 1, wherein the movement comprises a distance of the movement and the threshold measure of the movement comprises a threshold movement distance.

8. The method of claim 1, wherein the movement comprises acceleration of the movement and the threshold measure of the movement comprises a threshold acceleration.

9. The method of claim 1, wherein the movement comprises a direction of the movement and the threshold measure of the movement comprises a threshold direction.

10. The method of claim 1, wherein the movement comprises a duration of the movement and the threshold measure of the movement comprises a threshold duration.

11. The method of claim 1, wherein the movement comprises a frequency of the movement and the threshold measure of the movement comprises a threshold frequency.

12. The method of claim 1, wherein the movement comprises a amplitude of the movement and the threshold measure of the movement comprises a threshold amplitude.

13. The method of claim 1, further comprising:
sending one of (i) a parking reservation request to create the reservation, and (ii) a request to update the reservation wherein the reservation has been created responsive to a previous parking reservation request.

14. The method of claim 1, wherein the input comprises an identifier of a user, a destination where the parking location is situated, and a period for the reservation.

15. A computer program product comprising one or more computer-readable tangible storage devices and computer-readable program instructions which are stored on the one or more storage devices and when executed by one or more processors, perform the method of claim 1.

16. A computer system comprising one or more processors, one or more computer-readable memories, one or more computer-readable tangible storage devices and program instructions which are stored on the one or more storage devices for execution by the one or more processors via the one or more memories and when executed by the one or more processors perform the method of claim 1.

17. A computer program product for parking reservation that encourages car-pooling, the computer program product comprising:
one or more computer-readable tangible storage devices;
program instructions, stored on at least one of the one or more storage devices, to receive at a first mobile data processing system representing an automobile, an input to create a reservation for a parking location;
program instructions, stored on at least one of the one or more storage devices, to detect a second mobile data processing system, wherein the second mobile data processing system is within a threshold distance of the first mobile data processing system;
program instructions, stored on at least one of the one or more storage devices, to determine whether a movement of the second mobile data processing system relative to the first mobile data processing system is less than a threshold measure of the movement; and
program instructions, stored on at least one of the one or more storage devices, to apply, responsive to the determining being affirmative, a qualifier to the reservation to obtain a benefit in the reservation, wherein the qualifier accrues a benefit to the reservation.

18. The computer program product of claim 17, further comprising:
program instructions, stored on at least one of the one or more storage devices, to detect that a device has joined the group of co-located devices;
program instructions, stored on at least one of the one or more storage devices, to evaluate whether a number of devices in the group of the co-located devices has reached a threshold number; and
program instructions, stored on at least one of the one or more storage devices, to set, responsive to the number of devices in the group of the co-located devices reaching the threshold number, a status of the group of co-located devices as a car-pool.

19. The computer program product of claim 17, further comprising:
program instructions, stored on at least one of the one or more storage devices, to detect that a device has left the group of co-located devices;
program instructions, stored on at least one of the one or more storage devices, to evaluate whether a number of devices in the group of the co-located devices is less than a threshold number; and
program instructions, stored on at least one of the one or more storage devices, to set, responsive to the number of devices in the group of the co-located devices being less than the threshold number, a status of the group of co-located devices as other than a car-pool.

20. A computer system for parking reservation that encourages car-pooling, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to receive at a first mobile data processing system representing an automobile, an input to create a reservation for a parking location;
program instructions, stored on at least one of the one or more storage devices for execution by at least one of the one or more processors via at least one of the one or more memories, to detect a second mobile data processing system, wherein the second mobile data processing system is within a threshold distance of the first mobile data processing system;
program instructions, stored on at least one of the one or more storage devices for execution by at least one of the one or more processors via at least one of the one or more memories, to determine whether a movement of the second mobile data processing system relative to the first mobile data processing system is less than a threshold measure of the movement; and
program instructions, stored on at least one of the one or more storage devices for execution by at least one of the one or more processors via at least one of the one or more memories, to apply, responsive to the determining being affirmative, a qualifier to the reservation to obtain a benefit in the reservation, wherein the qualifier accrues a benefit to the reservation.
